(19) United States
(12) Patent Application Publication
(10) Pub. No.: US 2009/0154023 A1
(43) Pub. Date: Jun. 18, 2009

(54) Electromagnetic damping locking apparatus for the disk drive unit

(75) Inventor: MingGao Yao, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 12/000,443

(22) Filed: Dec. 12, 2007

(51) Int. Cl. G11B 5/54

(52) U.S. Cl. 360/256.2

(57) ABSTRACT

An electromagnetic damping apparatus for locking an actuator for a head stack assembly including at least one read/write head thereon is provided. In certain example embodiments, the electromagnetic damping apparatus may comprise a magnetic element and a metal element that cooperate in response to an electromagnetic field created by a current (e.g. an eddy current) to lock the actuator in a predetermined position. One of said magnetic element and said metal element may be fixed, and the other one may be movable by said actuator. The damping apparatus may be operable to selectively apply the current to lock the actuator by preventing the magnetic element and the metal element from moving apart. Certain electromagnetic damping apparatuses may be used with a disk drive device.

### FIELD OF THE INVENTION

The example embodiments herein relate to information recording disk drive devices, and, more particularly, to a locking apparatus that uses electromagnetic damping within a disk drive device to lock an actuator, thereby preventing a head stack assembly movable by the actuator from moving.

### BACKGROUND OF THE INVENTION

One known type of information storage device is a disk drive device that uses magnetic media to store data and a movable read/write head that is positioned over the media to selectively read from or write to the disk.

FIGS. 1 and 2 illustrate a conventional disk drive unit and show a magnetic disk 101 mounted on a spindle motor 103 for spinning the disk 101. A voice coil motor arm 146 carries a head gimbal assembly (HGA) 102 that includes a micro-actuator with a slider 105 incorporating a read/write head. A voice-coil motor (VCM) is provided for controlling the motion of the motor arm 146 and, in turn, controlling the slider 105 to move from track to track across the surface of the disk 101, thereby enabling the read/write head to read data from or write data to the disk 101.

The arm 146, which is installed on a base plate (not show) of the disk drive unit, rotates around a pivot hole 148 formed in the middle of the arm. The VCM includes a coil 156 that is coupled with the other end of the arm 146. The elements may be collectively referred to a head stack assembly (HSA). A lower yoke 151 is installed under the coil 156, with the lower yoke 151 being fixed to the base plate of the disk drive unit and spaced a predetermined distance apart from the coil 156. An upper yoke 152 is installed above the coil 156, while a magnet 154 is attached to the bottom surface thereof. In an alternative arrangement, the magnet 154 also may be attached to a top surface of the lower yoke 151.

The VCM is controlled by a servo control system (not shown), which rotates the slider 105 of the actuator from the parking zone to the data zone when the disk drive unit is turned on, and rotates the head (attached to the slider 105) from the data zone to the parking zone when the disk drive unit is turned off. FIG. 1 shows the arm 146 (and the entire head stack assembly) in the parking zone (dashed lines) and in the outer edges of the data zone (solid lines).

In a conventional hard disk drive during reading/writing, a lifting force caused by the rotation of the disk 101 and an elastic force generated by the HGA 102 lift the slider 105 to a height at which the lifting force and the elastic force balance each other. Thus, the magnetic head mounted on slider 105 is maintained at a constant distance from the disk 101. When the hard disk drive is turned off and the rotation of the disk 101 stops, however, the lifting force diminishes. Thus, one or more of the following parts may become damaged if the head stack assembly is left in the data zone position or is free to move about: the disk 101, the slider 105, the magnetic head mounted on the slider 105, etc.

One conventional approach to preventing such damage is to move the slider 105 to the parking zone and lock it there. Locking apparatuses may prevent rotations caused by external shocks or vibrations, which could damage the above-mentioned components, by generally preventing a head from escaping from the parking zone and moving to the data zone. The interaction between the current input into the coil 156 and the magnetic field formed by the magnet 154 allows the head to be controlled by the servo through the VCM.

Certain locking apparatuses shown in the enlarged portion of FIG. 2 include a damping member 164, a metal piece 165, and a coupling protrusion 162, located on the end of the VCM. A contact part 166 located on the upper yoke 152 may crash-stop into the damping member 164. The damping member 164 may absorb some of the shock. In such conventional systems, the metal piece 165 may be held in place with mechanical mechanisms, thereby preventing improper rotations.

While such arrangements were improvements over previous techniques, they still suffer several disadvantages. For example, the damping member 164 is an actual, physical element in a hard disk drive, requiring its own complete structure. Thus, the manufacturing and installation costs associated with such mechanisms are comparatively expensive. Another disadvantage relates to the actual process of crash-stopping into the physical damping member 164. Specifically, damping members require physical contact. This additional physical contact may cause additional stresses and/or vibrations. Additional stresses and/or vibrations may, in turn, cause HGA vibration and/or contact with the disk, resulting in damage to the head, disk, etc.

Thus, it will be appreciated that there is a need for an improved system that does not suffer from one or more of the above-mentioned drawbacks.

### SUMMARY OF THE INVENTION

One aspect of the present invention relates to an electromagnetic damping apparatus for locking an actuator for a head stack assembly including at least one read/write head thereon. In certain example embodiments, the electromagnetic damping apparatus may comprise a magnetic element and a metal element that cooperate in response to an electromagnetic field created by a current to lock the actuator in a predetermined position. One of said magnetic element and said metal element may be fixed, and the other one may be movable by said actuator. The damping apparatus may be operable to selectively apply the current to lock the actuator by preventing the magnetic element and the metal element from moving apart. The current applied preferably will be an eddy current.

In certain example embodiments, the magnetic element will have a magnetic polarization of either north or south. The magnetic element may be located on the head stack assembly, and the metal element may be located behind the magnetic element but not on the head stack assembly. In such embodiments, the metal element may be V-shaped, and the predetermined position may be a position where a center axis of the head stack assembly is aligned with one edge of the metal element.

In certain other example embodiments, the metal element may be located on the head stack assembly, and the magnetic element may be located behind the metal element but not on the head stack assembly. In such embodiments, the magnetic element may be V-shaped, and the predetermined position may be a position where a center axis of the head stack assembly is aligned with one edge of the magnetic element.

Another aspect of the present invention relates to a disk drive device. Certain example embodiments may comprise a head stack assembly including a head gimbal assembly having a slider with a read/write head thereon and a drive arm connected to the head gimbal assembly. A disk operable to be read from and/or written to by said read/write head and a spindle motor operable to spin the disk also may be included. Additionally, an electromagnetic damping apparatus for locking an actuator for the head stack assembly may be included. The electromagnetic damping apparatus may further comprise a magnetic element and a metal element that cooperate in response to an electromagnetic field created by a current to lock the actuator in a predetermined position. One of said magnetic element and said metal element may be fixed and the other one may be movable by the actuator. The damping apparatus may be operable to selectively apply the current to lock the actuator by preventing the magnetic element and the metal element from moving apart. The current applied preferably will be an eddy current.

In certain example embodiments, the electromagnetic damping apparatus may be further operable to cause the actuator to move the head stack assembly from a data zone position corresponding to a position where the read/write head can read data from and/or write data to the disk, to the predetermined position. The predetermined position may be a parking zone where the read/write head cannot read data from and/or write data to the disk.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a schematic representation of a conventional hard disk drive, showing an actuator in data and parking zones;

FIG. 2 is a perspective view of a conventional actuator and voice coil motor, with an exploded view of an actuator locking apparatus;

FIG. 3A is a detailed perspective view of a hard disk drive in accordance with an example embodiment;

FIG. 3B is a detailed view of a hard disk drive with an eddy current damping locking apparatus in accordance with an example embodiment;

FIG. 3C is a detailed perspective view of an HSA in accordance with an example embodiment;

FIG. 3D is a detailed perspective view of an HSA with magnetic and metal elements in accordance with an example embodiment;

FIG. 3E is a portion of a hard disk drive showing an HSA with magnetic and metal elements in accordance with an example embodiment;

FIG. 3F is a detailed perspective view of an HSA with magnetic and metal elements in accordance with an example embodiment;

FIG. 4A is a detailed perspective view of a hard disk drive in accordance with an example embodiment;

FIG. 4B is a detailed perspective view of an HSA with magnetic and metal elements in accordance with an example embodiment;

FIG. 4C is a portion of a hard disk drive showing an HSA with magnetic and metal elements in accordance with an example embodiment;

FIG. 4D is a detailed perspective view of an HSA with magnetic and metal elements in accordance with an example embodiment;

FIG. 5A is a detailed view of another HSA, metal element, and magnetic element, in accordance with an example embodiment; and,

FIG. 5B is a view of another VCM, metal element, and magnetic element, in accordance with an example embodiment.

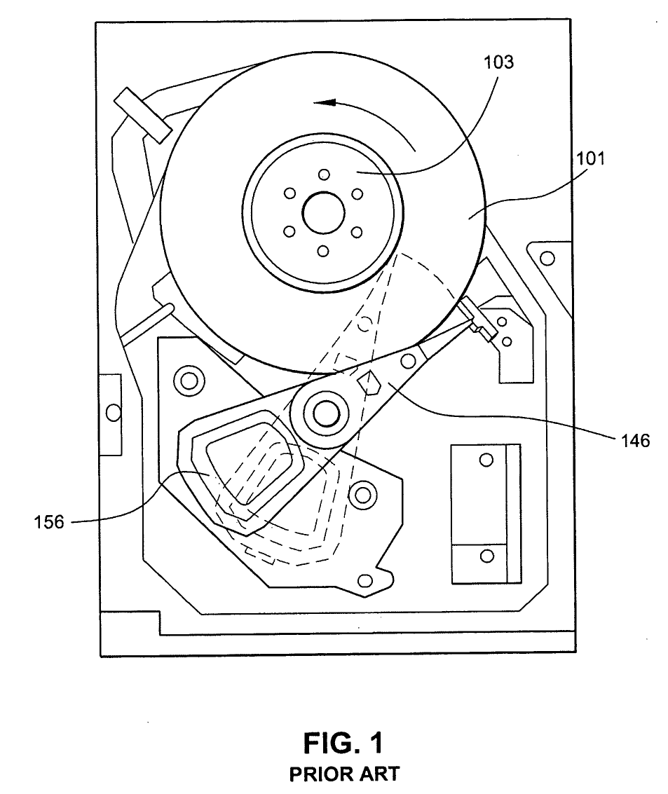

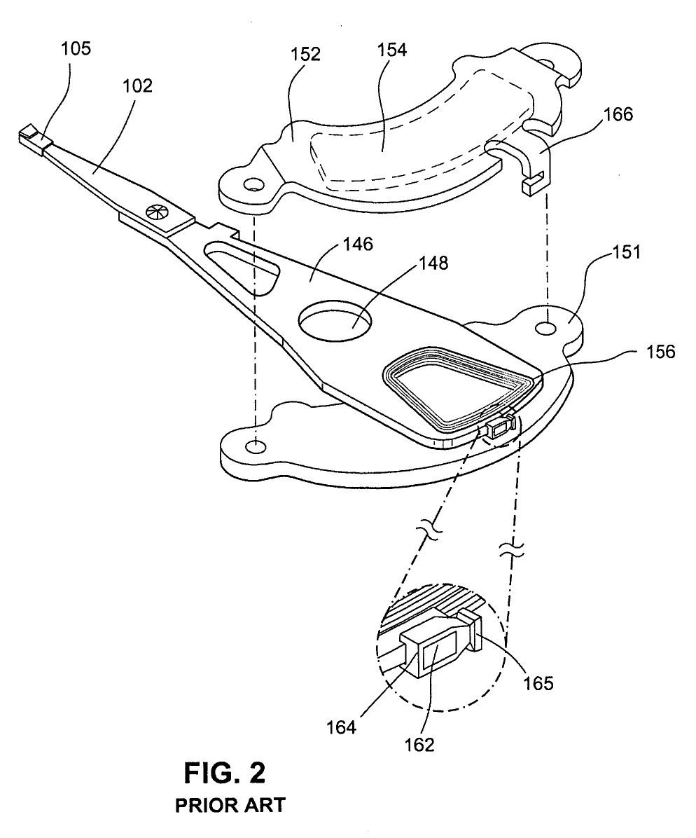

### DETAILED DESCRIPTION OF ILLUSTRATED EMBODIMENTS

Certain example embodiments use magnetic fields to achieve damping, thus eliminating the need for physical damping devices required by conventional locking apparatuses. According to certain example embodiments, damping devices may comprise a metal element and one or more magnetic elements. For example, either the magnetic element or the metal element may be installed at the end of the coil of the VCM, depending on the particular embodiment. Other alternative arrangements, potentially comprising multiple magnetic and/or metal elements are possible, such as, for example, locating metal or magnetic elements on either side of the coil rather than simply at its end. Regardless of the specific embodiment chosen, an electromagnetic damping preferably occurs. This damping prevents the movement of the particular element (either the metal element or the magnetic element, depending on the particular example embodiment) located at the end of the coil of the VCM. Thus, according to certain example embodiments, damping occurs without a physical locking apparatus that requires a crash-stop.

A preferred embodiment may use an eddy current to create an electromagnetic field to perform the damping. Eddy currents may retard motion or cause deceleration within a moving system. An eddy current occurs when a moving magnetic field intersects a conductor, or vice-versa. The relative motion causes a circulating flow of electrons, or current, within the conductor. These circulating eddies of current create electromagnets with magnetic fields that oppose the change in the external magnetic field. In general, the stronger the magnetic field (or the greater the electrical conductivity of the conductor), the greater the currents developed, and thus the greater the opposing force. Resistance within the conductor may cause a dragging effect, which can be used in braking and damping. These techniques are advantageous because, for example, they have substantially no mechanical wear and are capable of producing very precise damping forces. Unlike conventional brakes (which cause friction between moving parts) and conventional damping parts within a hard disk drive (which require physical contact in the form of a crash-stop), kinetic energy may be converted to heat without contact between the moving parts by using eddy current damping techniques.

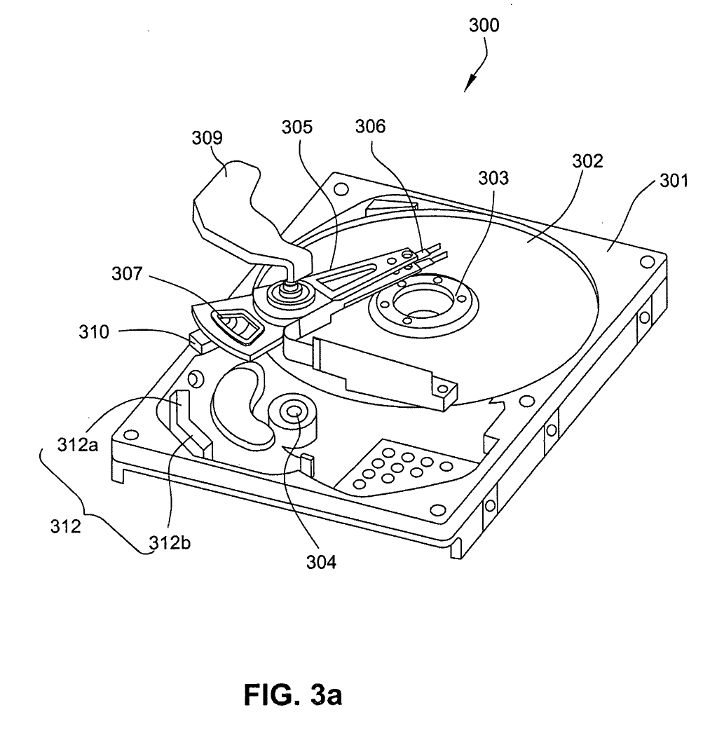

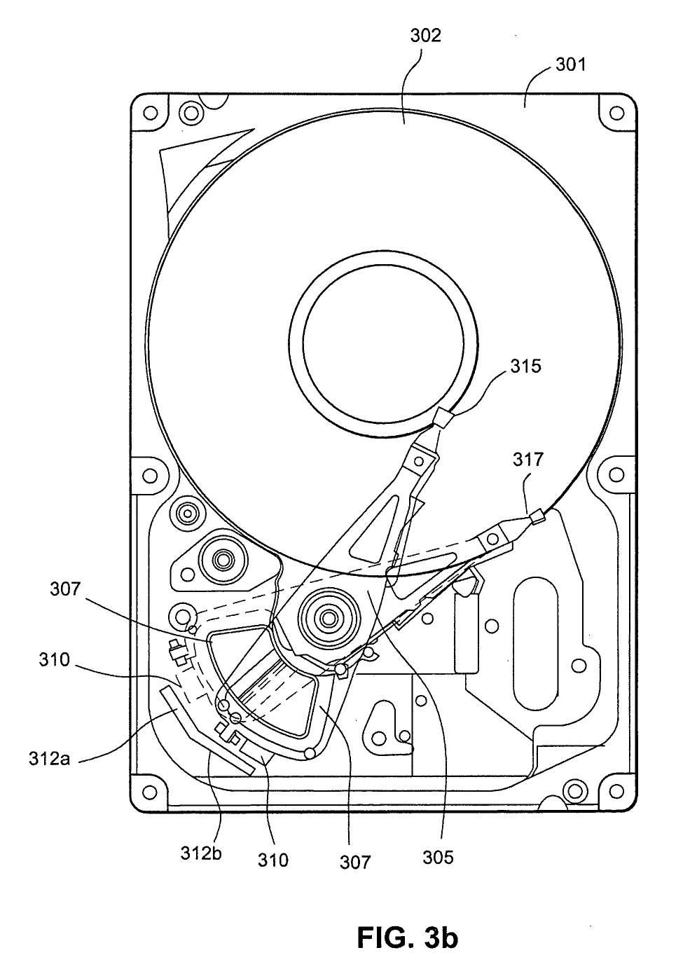

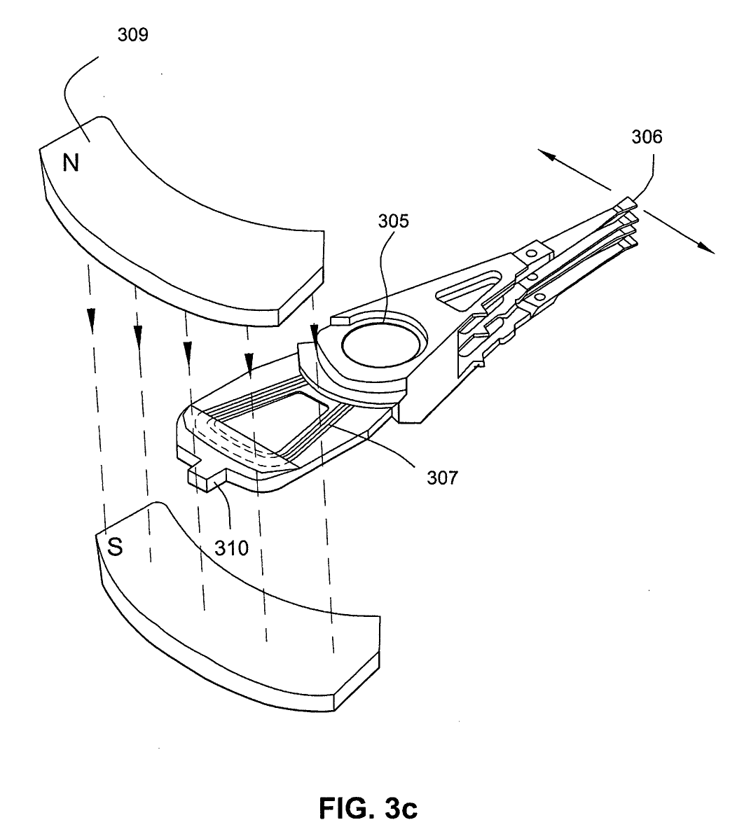

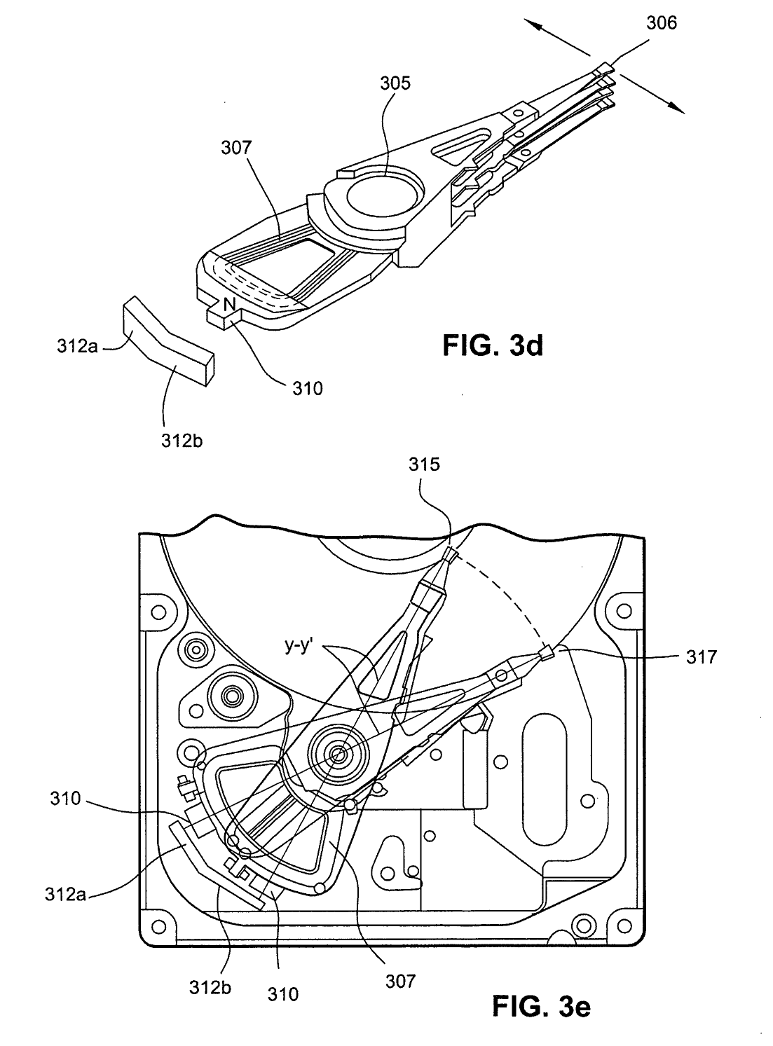

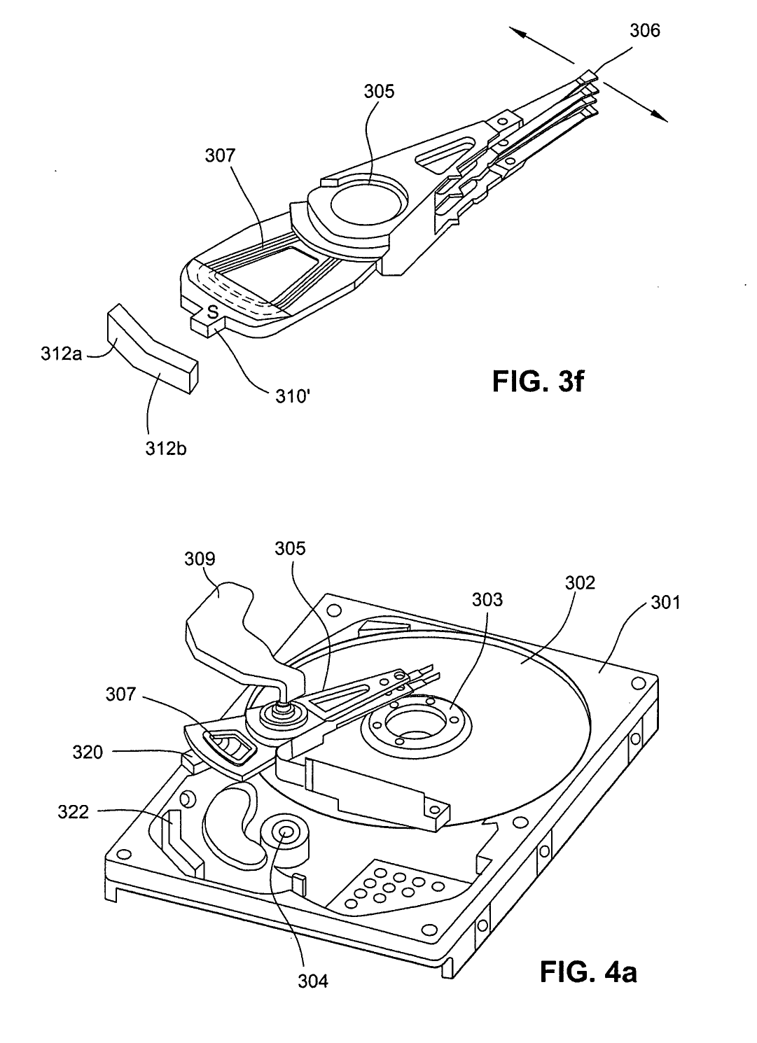

Referring now more particularly to the accompanying drawings in which like reference numerals indicate like parts throughout the several views, FIG. 3A is a detailed perspective view of a hard disk drive 300 according to an example embodiment. In FIG. 3A, the hard disk drive 300 is comprised of a base 301, a spindle 303 about which a single or multiple disks 302 rotate, and a bearing 304 which supports a head stack assembly (HSA) 305. Coil 307 is located towards the end of HSA 305, and a magnetic yoke 309 is placed on top of the coil 307. A magnetic element 310 is installed in the end of the HSA 305. It will be appreciated that the magnetic element 310 may be of almost any shape and/or size so long as it fits within the larger hard disk drive assembly and is capable of responding to the electromagnetic field created. Additionally, the magnetic element 310 preferably is part of, welded to, or attached with an adhesive to, the middle of the coil holder. It will be appreciated that in certain example embodiments, other techniques for attaching the magnetic element 310 to the coil holder, directly or indirectly, may be used in place of, or in combination with, the above-described techniques.

A metal element 312 is installed in the base 301. Preferably, the metal element 312 is V-shaped and faces the magnetic element 310. The V-shaped metal element 312 may include two parts 312a-b which face the magnetic element 310 when the head is in the data zone and in the landing zone. It will be appreciated that other shapes may be used instead of the V-shape.

FIG. 3B is a detailed view of a hard disk drive with an eddy current damping locking apparatus, in accordance with an example embodiment. As noted above, the HSA 305 is supported by the bearing 304 located in its middle region. The HSA 305 supports the magnetic head and positions it in either in the landing zone 315 or the data zone 317. When the power of the hard disk drive is turned off, the head stays in the landing zone 315, while the magnetic element 310 faces part 312b of the metal element 312. For example, the edge of part 312b of the metal element 312 may be aligned with a center axis of the HSA 305. Similarly, when the head is in the data zone 317, the magnetic element 310 will face the metal element 312a. For example, the edge of part 312a of the metal element 312 may be aligned with a center axis of vertical with the axis of the HSA 305. FIG. 3e, described in further detail below, shows center axes y and y′ when the HAS 305 is in the data and landing zones.

FIG. 3C is a detailed perspective view of an HSA in accordance with an example embodiment. The magnetic element 309 is capable of generating a magnetic filed, as indicated by the dashed directional lines. Coil 307 is installed between magnetic elements within the magnetic filed. When a current is applied to the coil 307 (e.g. when the servo instructs the head to start reading/writing data, etc.), the current will induce the coil 307 to move under the magnetic field, which, in turn, will move the head from one zone to the other. It will be appreciated that the polarization of the magnetic elements may be reversed, depending on the particular embodiment implemented.

FIGS. 3D and 3E help illustrate how an eddy current damping locking apparatus according to an example embodiment works. In particular, FIG. 3D is a detailed perspective view of an HSA with magnetic and metal elements in accordance with an example embodiment. FIG. 3E is a portion of a hard disk drive showing an HSA with magnetic and metal elements in accordance with an example embodiment. A magnetic element 310 with a polarization of magnetic north extends backward from the actuator. When the VCM moves the head from data zone to the landing zone (e.g. when the hard disk drive is turned off), the magnetic element 310 will move and face part 312b of the metal element 312 located at the base of the hard disk drive. Electromagnetic damping between the metal 312b and the magnetic element 310 will happen, which will quick-stop the end of the HSA 305 having the magnetic element 310 while also locking the HSA 305 in place.

Similarly, when the head begins reading data from or writing data to the disk, the head may move towards to the data zone 317. Eddy current damping may occur before the outer track is reached, but the magnetic force between the magnetic element 310 and the metal 312b should be smaller than the VCM moving force generated by the magnetic element 309. The eddy currents may have no (or substantially no) effect on the head when moving form track to track, whereas the electromagnetic damping may continue to increase and achieve the greatest damping effect when moving the head to the outer track of the data zone 317. Also, when the magnetic element 310 faces the part 312a of the metal element 312, the eddy current damping may lock the VCM and prevent the head from moving.

FIG. 3F is like FIG. 3D, in that it is a detailed perspective view of an HSA with magnetic and metal elements in accordance with an example embodiment. However, FIG. 3F shows magnetic element 310′ with a polarization of magnetic south extending backward from the HSA.

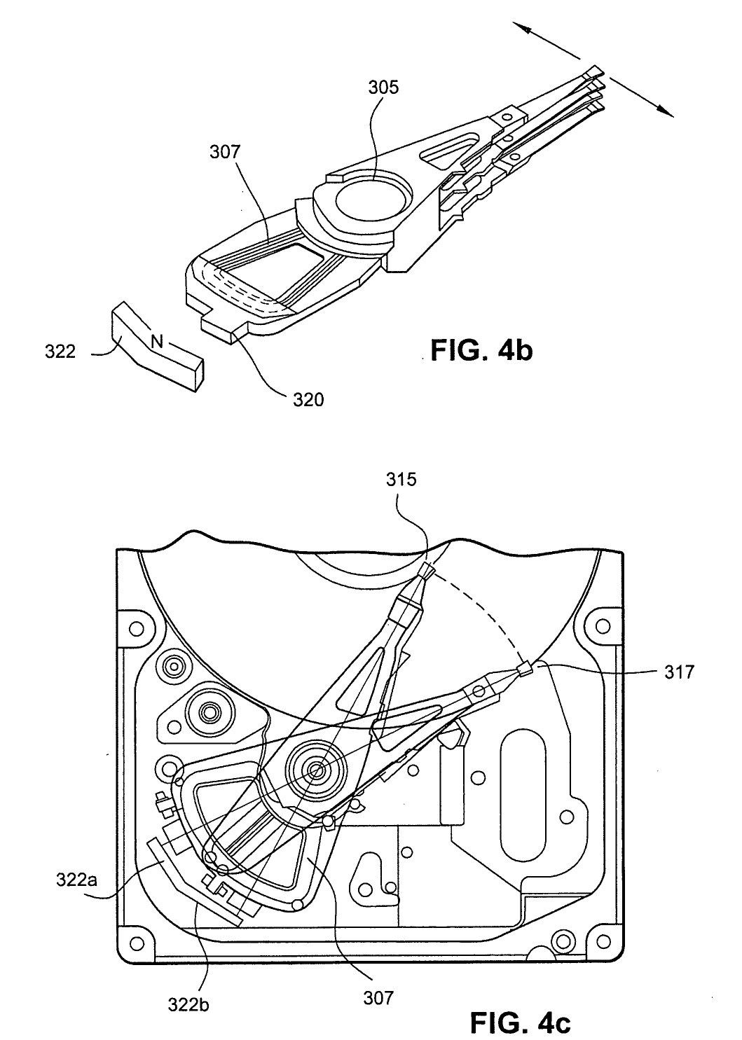

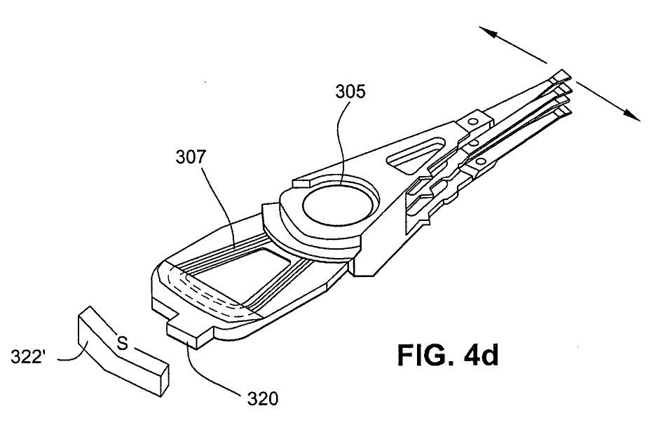

FIG. 4A is a detailed perspective view of a hard disk drive according to an example embodiment. FIG. 4A is like FIG. 3A. However, in FIG. 4A, a metal element 320 is installed in the end of the HSA 305. It will be appreciated that the metal element 320 may be of almost any shape and/or size so long as it fits within the larger hard disk drive assembly and is capable of responding to the electromagnetic field created. Additionally, the metal element 320 preferably is part of, welded to, or attached with an adhesive to the middle of the coil holder. It will be appreciated that in certain example embodiments, other techniques for attaching the metal element 320 to the coil holder, directly or indirectly, may be used in place of, or in combination with, the above-described techniques.

A magnetic element 322 is installed in the base 301. Preferably, the magnetic element 322 is V-shaped and faces the metal element 320. The V-shaped magnetic element 322 may include two parts 322a-b (shown in FIG. 4C) which face the metal element 320 when the head is in the data zone and in the landing zone. It will be appreciated that other shapes may be used instead of the V-shape.

FIGS. 4B and 4C help illustrate how an eddy current damping locking apparatus according to an example embodiment works. In particular, FIG. 4B is a detailed perspective view of an HSA with magnetic and metal elements in accordance with an example embodiment. FIG. 4C is a portion of a hard disk drive showing an actuator with magnetic and metal elements in accordance with an example embodiment.

A magnetic element 322 with a polarization of magnetic north extends is located on the behind the HSA. When the VCM moves the head from data zone to the landing zone (e.g. when the hard disk drive is turned off), the metal element 320 will move and face part 322b of the magnetic element 322 located at the base of the hard disk drive. Electromagnetic damping between the part 322b of the magnetic element 322 and the metal element 320 will happen, which will quick-stop the end of the HSA 305 having the metal element 320 while also locking the HSA 305 in place.

Similarly, when the head begins reading data from or writing data to the disk, the head may move towards to the data zone 317. Eddy current damping may occur before the outer track is reached, but the magnetic force between the metal element 320 and the part 322b of the magnetic element 322 should be smaller than the VCM moving force generated by the magnetic element 309. The eddy currents may have no (or substantially no) effect on the head when moving form track to track, whereas the electromagnetic damping may continue to increase and achieve the greatest damping effect when moving the head to the outer track of the data zone 317. Also, when the metal element 320 faces the part 322a of the magnetic element 322, the eddy current damping may lock the VCM and prevent the head from moving.

As noted above, the HSA 305 is support by the bearing 304 located in its middle region. The HSA 305 supports the magnetic head and positions in either in the landing zone 315 or the data zone 317. When the power of the hard disk drive is turned off, the head stays in the landing zone 315, while the metal element 320 faces part 322b of the magnetic element 322. For example, the edge of part 322b of the magnetic element 322 may be aligned with a center axis of the HSA 305. Similarly, when the head is in the data zone 317, the metal element 320 will face the magnetic element 322a. For example, the edge of part 322a of the magnetic element 322 may be aligned with a center axis of vertical with the axis of the HSA 305.

FIG. 4D is like FIG. 4B, in that it is a detailed perspective view of an actuator with magnetic and metal elements in accordance with an example embodiment. However, FIG. 4D shows magnetic element 322′ with a polarization of magnetic south located behind the actuator.

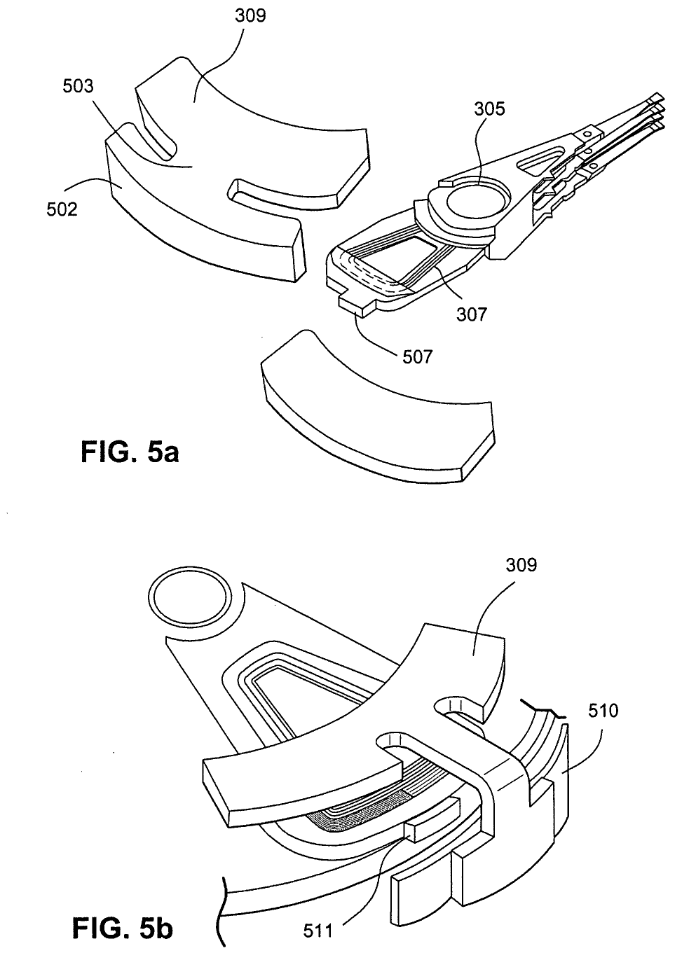

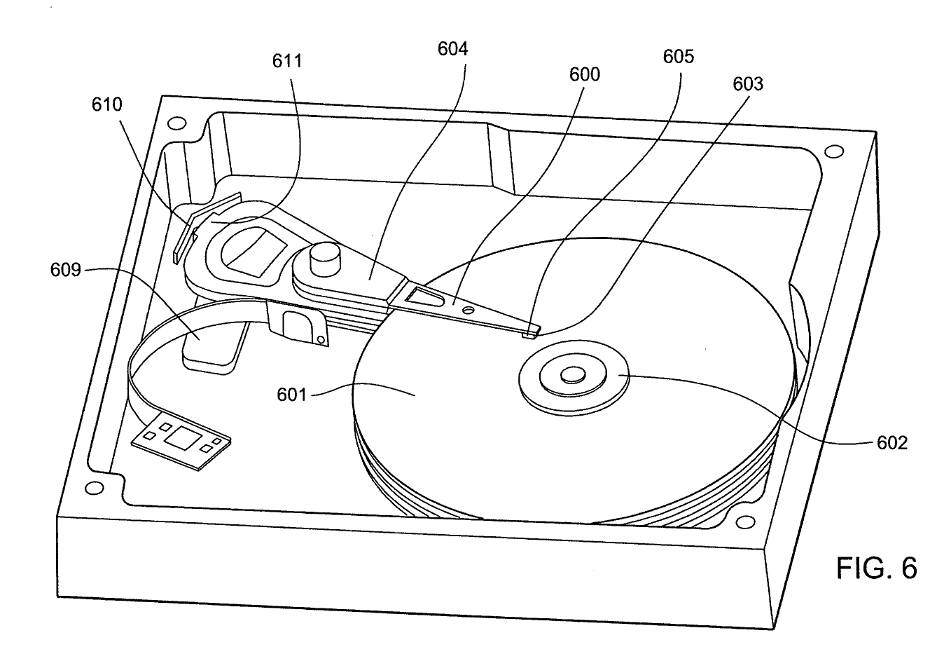

FIG. 5A is a detailed view of another HSA, metal element, and magnetic element, in accordance with an example embodiment. In FIG. 5A, the electromagnetic damping locking apparatus may comprise a metal element 507 located an the end of the HSA, extending from a side of the coil 307. A neck 503 may extend backward from magnetic element 309, and magnetic element 502 for use with the metal element 507 may extend vertically downward therefrom. In certain other example embodiments, the positions of the metal element and the magnetic element may be switched such that the magnetic element is located at the end of the coil 307 and the metal element extends vertically downward from the neck 503 attached to the magnetic element 309.

FIG. 5B is a view of another VCM, metal element, and magnetic element, in accordance with an example embodiment. Metal element 511 may be located at the end of the coil 307. Magnetic element 510 may be attached to the VCM magnetic element 309, by, for example, vertically attaching it thereto.

FIG. 6 illustrates a disk drive unit and shows a locking apparatus 610-611 mounted thereon. Magnetic disk 601 is mounted on a spindle motor 602 for spinning the disk 101. A voice coil motor arm 604 carries a HGA 600 that includes a micro-actuator 605 with a slider 603 incorporating a read/write head. A voice-coil motor (VCM) is provided for controlling the motion of the motor arm 604 and, in turn, controlling the slider 603 to move from track to track across the surface of the disk 601, thereby enabling the read/write head to read data from or write data to the disk 601. In operation, a lift force is generated by the aerodynamic interaction between the slider 603, incorporating the read/write transducer, and the spinning magnetic disk 601. Preferably, eddy currents create an electromagnetic field such that the locking apparatus 610-611 will cause the arm 604 to move between a data zone and a parking zone as appropriate. It will be appreciated that part 610 may be a metal element and part 611 may be a magnetic element, or vice versa. Also, it will be appreciated that parts 610-611 may be of different sizes and shapes from those shown.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An electromagnetic damping apparatus for locking an actuator for a head stack assembly including at least one read/write head thereon, said electromagnetic damping apparatus comprising:
a magnetic element and a metal element that cooperate in response to an electromagnetic field created by a current to lock the actuator in a predetermined position;
wherein one of said magnetic element and said metal element is fixed and the other one is movable by said actuator, and further wherein the damping apparatus is operable to selectively apply the current to lock the actuator by preventing the magnetic element and the metal element from moving apart.

2. The electromagnetic damping apparatus of claim 1, wherein said magnetic element has a magnetic polarization of either north or south.

3. The electromagnetic damping apparatus of claim 1, wherein the current is an eddy current.

4. The electromagnetic damping apparatus of claim 1,
wherein the magnetic element is located on the head stack assembly;
and further wherein the metal element is located behind the magnetic element but not on the head stack assembly.

5. The electromagnetic damping apparatus of claim 4, wherein the metal element is V-shaped.

6. The electromagnetic damping apparatus of claim 1, wherein the predetermined position is a position where a center axis of the head stack assembly is aligned with one edge of the metal element.

7. The electromagnetic damping apparatus of claim 1,
wherein the metal element is located on the head stack assembly;
and further wherein the magnetic element is located behind the metal element but not on the head stack assembly.

8. The electromagnetic damping apparatus of claim 7, wherein the magnetic element is V-shaped.

9. The electromagnetic damping apparatus of claim 1, wherein the predetermined position is a position where a center axis of the head stack assembly is aligned with one edge of the magnetic element.

10. The electromagnetic damping apparatus of claim 1, wherein the predetermined position is a parking zone.

11. A disk drive device, comprising:
a head stack assembly including a head gimbal assembly having a slider with a read/write head thereon and a drive arm connected to the head gimbal assembly;
a disk operable to be read from and/or written to by said read/write head;
a spindle motor operable to spin the disk; and
an electromagnetic damping apparatus for locking an actuator for the head stack assembly,
wherein said electromagnetic damping apparatus further comprises:
a magnetic element and a metal element that cooperate in response to an electromagnetic field created by a current to lock the actuator in a predetermined position;
wherein one of said magnetic element and said metal element is fixed and the other one is movable by said actuator, and further wherein the damping apparatus is operable to selectively apply the current to lock the actuator by preventing the magnetic element and the metal element from moving apart.

12. The disk drive device of claim 10, wherein said magnetic element has a magnetic polarization of either north or south.

13. The disk drive device of claim 10, wherein the current is an eddy current.

14. The disk drive device of claim 10,
wherein the magnetic element is located on the head stack assembly;
and further wherein the metal element is located behind the magnetic element and within the disk drive device but not on the head stack assembly.

15. The disk drive device of claim 14, wherein the metal element is V-shaped.

16. The disk drive device of claim 10, wherein the predetermined position is a position where a center axis of the head stack assembly is aligned with one edge of the metal element.

17. The disk drive device of claim 10,
wherein the metal element is located on the head stack assembly;
and further wherein the magnetic element is located behind the metal element and within the disk drive device but not on the head stack assembly.

18. The disk drive device of claim 17, wherein the magnetic element is V-shaped.

19. The disk drive device of claim 1, wherein the predetermined position is a position where a center axis of the head stack assembly is aligned with one edge of the magnetic element.

20. The disk drive device of claim 10, wherein the electromagnetic damping apparatus is further operable to cause the actuator to move the head stack assembly from a data zone position corresponding to a position where the read/write head can read data from and/or write data to the disk, to said predetermined position, said predetermined position being a parking zone where the read/write head cannot read data from and/or write data to the disk.
